(19) United States
(12) Patent Application Publication
(10) Pub. No.: US 2023/0186367 A1
(43) Pub. Date: Jun. 15, 2023

(54) Transaction Recommendation and Purchasing Engine

(71) Applicant: Capital One Services, LLC, McLean, VA (US)

(72) Inventors: Lin Ni Lisa Cheng, New York, NY (US); Xiaoguang Zhu, New York, NY (US); Vyjayanthi Vadrevu, Pflugerville, TX (US)

(73) Assignee: Capital One Services, LLC, McLean, VA (US)

(21) Appl. No.: 17/643,478

(22) Filed: Dec. 9, 2021

(51) Int. Cl. G06Q 30/06; G06Q 10/08; G06N 20/00

(52) U.S. Cl. CPC G06Q 30/0631; G06N 20/00; G06Q 10/087; G06Q 30/0619; G06Q 30/0633; G06Q 30/0639

(57) ABSTRACT

A computing system retrieves historical transaction data associated with a plurality of users. The historical transaction data includes stock-keeping unit (SKU) level data. The computing system trains a first prediction model to identify transaction patterns across the plurality of users and relationships between items to each transaction based on the historical transaction data. The computing system accesses transaction data corresponding to a first user of the plurality of users. The computing system generates a second prediction model by fine-tuning the first prediction model based on the transaction data of the first user. The computing system receives inventory data corresponding to one or more merchants with which the first user has transacted. The computing system accesses a news feed to identify upcoming events or ongoing events. The second prediction model learns a baseline spending pattern of the first user based on the transaction data. The computing system recommends a new transaction for the first user based on the baseline spending pattern, the inventory data, and the news feed.

### FIELD OF THE DISCLOSURE

Embodiments disclosed herein generally relate a transaction recommendation and purchasing engine.

### BACKGROUND

National or local emergencies, such as pandemics or turbulent weather, typically lead to consumer hysteria. News stations frequently recommend that users purchase goods in bulk in case there are supply chain or transportation issues that may prevent the user from purchasing essential items in the future. While preparation is important, it is often the case that consumers overestimate the amount of essentials that they require.

### SUMMARY

In some embodiments, a non-transitory computer readable medium is disclosed herein. The non-transitory computer readable medium includes one or more sequences of instructions, which, when executed by a processor, causes a computing system to perform operations. The operations include generating, by the computing system, a first prediction model to identify baseline spending patterns across a plurality of users and relationships between items by generating, by the computing system, a training data set that includes historical transaction data associated with the plurality of users, wherein the historical transaction data that includes stock-keeping unit (SKU) level data, learning, by the first prediction model, to generate the baseline spending patterns based on the historical transaction data, and learning, by the first prediction model, the relationships between items to an order based on the historical transaction data. The operations further include generating, by the computing system, an individualized prediction model for a first user by accessing transaction data corresponding to the first user of the plurality of users, and learning, by the individualized prediction model, a baseline spending pattern of the first user based on the transaction data. The operations further include receiving, by the computing system, inventory data corresponding to one or more merchants with which the first user has transacted. The inventory data includes SKU level data. The operations further include accessing, by the computing system, a news feed to identify upcoming events or ongoing events. The operations further include recommending, by the individualized prediction model, a new transaction for the first user based on the baseline spending pattern, the inventory data, and the news feed.

In some embodiments, the operations further include anonymizing, by the computing system, the historical transaction data prior to training the first prediction model with the historical transaction data.

In some embodiments, recommending, by the computing system, the new transaction for the first user based on the baseline spending patterns and the inventory data includes interfacing with an intelligent assistant to deliver the recommendation to the first user.

In some embodiments, recommending, by the computing system, the new transaction for the first user based on the baseline spending pattern and the inventory data includes determining, by the individualized prediction model, that stock for an item is expected to be depleted within a radius of the first user and, based on the determining, notifying the first user to purchase the item before the stock for the item is depleted within the radius.

In some embodiments, the operations further include, for each item in the transaction data, learning, by the first prediction model, a plurality of replacement items based on the transaction data.

In some embodiments, recommending, by the computing system, the new transaction for the first user based on the baseline spending pattern and the inventory data includes notifying the first user that a frequently purchased item is out of stock within a radius location of the first user and suggesting that the first user purchase a second item, wherein the second item is a replacement item for the frequently purchased item.

In some embodiments, the operations further include prompting, by the computing system, the first user to submit an order for the new transaction with a merchant.

In some embodiments, a method is disclosed herein. A computing system retrieves historical transaction data associated with a plurality of users. The historical transaction data includes stock-keeping unit (SKU) level data. The computing system trains a first prediction model to identify transaction patterns across the plurality of users and relationships between items to each transaction based on the historical transaction data. The computing system accesses transaction data corresponding to a first user of the plurality of users. The computing system generates a second prediction model by fine-tuning the first prediction model based on the transaction data of the first user. The computing system receives inventory data corresponding to one or more merchants with which the first user has transacted. The inventory data includes SKU level data. The computing system accesses a news feed to identify upcoming events or ongoing events. The second prediction model learns a baseline spending pattern of the first user based on the transaction data. The computing system recommends a new transaction for the first user based on the baseline spending pattern, the inventory data, and the news feed.

In some embodiments, the computing system anonymizes the historical transaction data prior to training the first prediction model with the historical transaction data.

In some embodiments, recommending, by the computing system, the new transaction for the first user based on the baseline spending pattern and the inventory data includes interfacing with an intelligent assistant to deliver the recommendation to the first user.

In some embodiments, the computing system recommending the new transaction for the first user based on the baseline spending pattern and the inventory data includes the second prediction model determining that stock for an item is expected to be depleted within a radius of the first user. Based on the determining, the computing system notifies the first user to purchase the item before the stock for the item is depleted within the radius.

In some embodiments, for each item in the transaction data, the first prediction model learns a plurality of replacement items based on the transaction data.

In some embodiments, the computing system recommending the new transaction for the first user based on the baseline spending pattern and the inventory data includes the computing system notifying the first user that a frequently purchased item is out of stock within a radius location of the first user; and suggesting that the first user purchase a second item, wherein the second item is a replacement item for the frequently purchased item.

In some embodiments, the computing system prompts the first user to submit an order for the new transaction with a merchant.

In some embodiments, a system is disclosed herein. The system includes a processor and a memory. The memory has programming instructions stored thereon, which, when executed by the processor, causes the processor to perform operations. The operations include generating a first prediction model to identify baseline spending patterns across a plurality of users and relationships between items by generating a training data set that includes historical transaction data associated with the plurality of users, wherein the historical transaction data includes stock-keeping unit (SKU) level data, learning, by the first prediction model, to generate the baseline spending patterns based on the historical transaction data, and learning, by the first prediction model, the relationships between items to an order based on the historical transaction data. The operations further include generating an individualized prediction model for a first user by accessing transaction data corresponding to the first user of the plurality of users, and learning, by the individualized prediction model, a baseline spending pattern of the first user based on the transaction data. The operations further include receiving inventory data corresponding to one or more merchants with which the first user has transacted, wherein the inventory data includes SKU level data. The operations further include accessing a news feed to identify upcoming events or ongoing events. The operations further include predicting, by the individualized prediction model, that the first user will need to re-order an item based on the baseline spending pattern, the inventory data, and the news feed. The operations further include, based on the predicting, recommending a new transaction for the first user.

In some embodiments, the operations further include anonymizing the historical transaction data prior to training the first prediction model with the historical transaction data.

In some embodiments, recommending the new transaction for the first user includes interfacing with an intelligent assistant to deliver the recommendation to the first user.

In some embodiments, predicting, by the individualized prediction model, that the user will need to re-order the item based on the baseline spending pattern, the inventory data, and the news feed includes determining, by the individualized prediction model, that stock for the item is expected to be depleted within a radius of the first user and, based on the determining, notifying the first user to purchase the item before stock for the item is depleted within the radius.

In some embodiments, the operations further include, for each item in the transaction data, learning, by the first prediction model, a plurality of replacement items based on the transaction data.

In some embodiments, recommending the new transaction for the first user includes notifying the first user that a frequently purchased item is out of stock within a radius of the first user and suggesting that the first user purchase a second item. The second item is a replacement item for the frequently purchased item.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to one exemplary embodiment.

FIG. 2 is a block diagram illustrating a machine learning platform, according to example embodiments.

FIG. 3 is a flow diagram illustrating a method of training machine learning platform, according to example embodiments.

FIG. 4 is a flow diagram illustrating a method of generating a recommended transaction, according to example embodiments.

FIG. 5A illustrates an architecture of system bus computing system, according to example embodiments.

FIG. 5B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

During an epidemic or unusual situation, human beings can be very irrational due to decisions made under fear or lack of preparation. This typically leads individuals to purchase unnecessary items or unnecessary quantity of items. Some individuals may go as far as extreme stockpiling, creating an unnecessary financial burden on their families. Some individuals may regret their purchases and return the purchased items, shifting the burden to retailers that now must deal with the overhead and loss due to high volumes of returns and wastes.

To help solve this issue, one or more techniques disclosed herein may utilizes SKU level transaction data from a variety of channels to compile aggregated information to provide to a suite of machine learning models to calculate and generate a baselines requirement list for the individuals. In some embodiments, the present system is able to refine the requirements for each individual by mapping those products with a product category. In this manner, a user may be provided with their baseline requirement in the form of a shopping list with purchase recommendations of essential items (such as medicine, house holder essentials, milk powder and diapers for toddlers, personal and feminine care products, seniors supplements, etc.) to purchase based on their purchase habits. Then user can adjust the volume based on their household needs. For example, if User A decides to make a procurement for the next four weeks instead of the user’s normal procurement cycle of two weeks, the present system can account for this change by remapping the additional volume to the product category and suggesting bulk packages.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

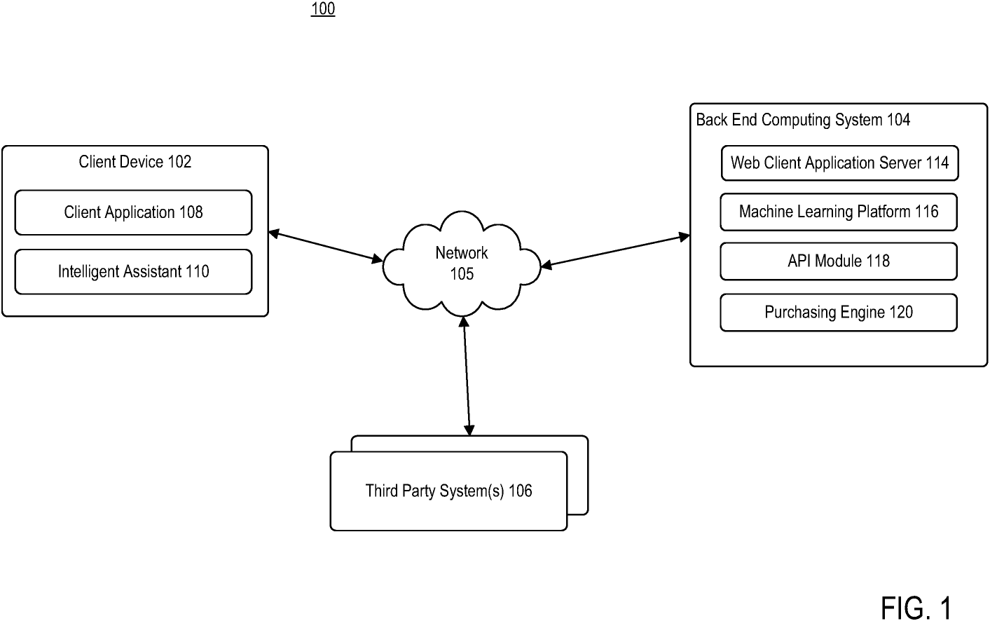

FIG. 1 is a block diagram illustrating a computing environment 100, according to one embodiment. Computing environment 100 may include at least a client device 102, a back-end computing system 104, and one or more third party systems 106 communicating via network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receive information between the components of computing environment 100.

Client device 102 may be operated by a user. For example, client device 102 may be a mobile device, a tablet, a desktop computer, or any computing system having the capabilities described herein. Client device 102 may include a client application 108. Client application 108 may be representative of an application executing on client device 102. Client application 108 may allow a user of client device 102 to access functionality of back-end computing system 104. For example, via client application 108, a user of client device 102 may view information regarding recommendations regarding a new transaction. In another example, via client application 108, a user of client device 102 may view information regarding an automatically generated shopping list for future consumption.

Client application 108 may be representative of a web browser that allows access to a website or a stand-alone application. Client device 102 may communicate over network 105 to request a webpage, for example, from web client application server 114 of back-end computing system 104. For example, client device 102 may be configured to execute application 108 to access content managed by back-end computing system 104. The content that is displayed to client device 102 may be transmitted from web client application server 114 to client device 102, and subsequently processed by application 108 for display through a graphical user interface (GUI) of client device 102. In some embodiments, such as when client application 108 is a web browser, client device 102 may access functionality of back-end computing system 104 via a browser extension.

In some embodiments, client application 108 may interface with other applications executing on client device 102. For example, client application 108, upon presenting a user with a proposed shopping list, may interface with a grocery delivery application executing on client device 102. In this manner, a user may place an order to items with another application through client application 108.

In some embodiments, client device 102 may further include intelligent assistant 110. Intelligent assistant 110 may be representative of a virtual software agent that can perform tasks or services for the user based on various commands (e.g., text commands, voice commands, etc.). For example, intelligent assistant 110 may be representative of Eno®, a virtual intelligent assistant commercially available from Capital One®. A user may interact with client application 108 and/or back-end computing system 104 using intelligent assistant 110.

Back-end computing system 104 may be configured to provide personalized recommendations for household purchases and a purchasing engine for initiating a purchase of the personalized recommendations. Back-end computing system 104 may include web client application server 114, machine learning platform 116, application programming interface (API) module 118, and purchasing engine 120. Each of machine learning platform 116, API module 118, and purchasing engine 120 may be comprised of one or more software modules. The one or more software modules may be collections of code or instructions stored on a media (e.g., memory associated with back-end computing system 104) that represent a series of machine instructions (e.g., program code) that implements one or more algorithmic steps. Such machine instructions may be the actual computer code a processor associated with back-end computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of an instructions.

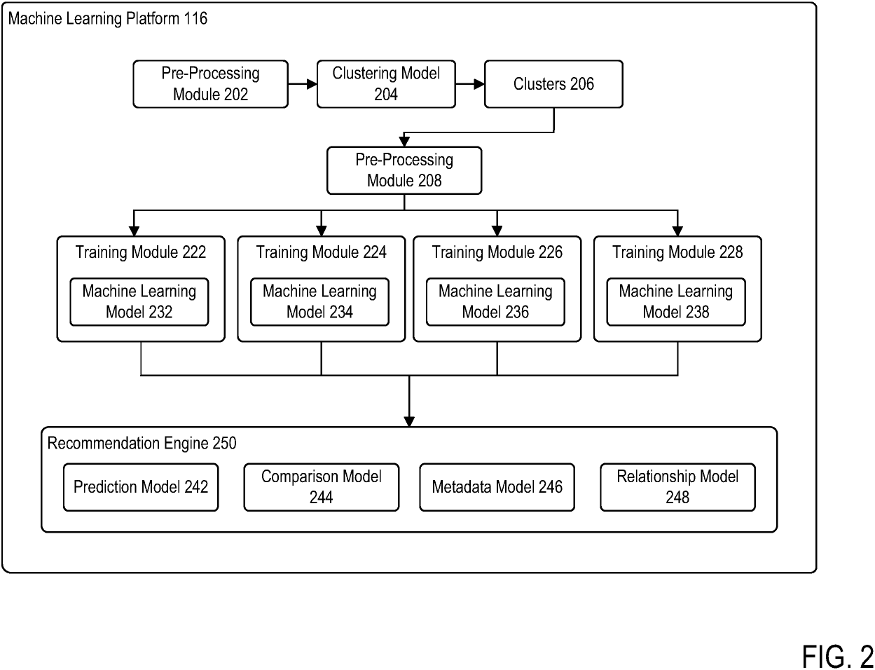

Machine learning platform 116 may be configured to provide personalized recommendations for household purchases. For example, machine learning platform 116 may be configured to learn personalized preferences of each user in its user base to generate personalized recommendations for household purchases. Machine learning platform 116 may be composed of a plurality of machine learning models, each machine learning model optimized for performing a function of the personalized recommendation process. Machine learning platform 116 is described in more detail below in conjunction with FIG. 2.

API module 118 may be configured to allow for communication between back-end computing system 104 and one or more third-party systems 106. For example, API module 118 may include a set of APIs, each API dedicated to a specific third-party system. Each API may be configured to facilitate communication between back-end computing system 104 and a respective third-party system 106 in accordance with various formats as defined by each respective third-party system 106. Via API module 118, back-end computing system 104 may dynamically receive or retrieve various information for training machine learning platform 116 and/or generating personalized recommendations to each user.

As shown, computing environment 100 includes one or more third party systems 106. In some embodiments, one or more third party systems 106 may include financial institutions associated with a user. For example, API module 118 may be configured to receive or retrieve transactional data from one or more financial institutions. In some embodiments, the transactional data may include SKU-level data that identifies that particular items the user has purchased.

In some embodiments, one or more third party systems 106 may include one or more retailers. For example, API module 118 may be configured to interface with one or more retailers to retrieve loyalty program data. In some embodiments, to receive the loyalty program data, a user may provide back-end computing system 104 with login information or personal identification information (e.g., loyalty number) to allow the API module 118 to pull or receive the correct information. Such loyalty program data may assist back-end computing system 104 in determining the particular items or category of items that the user purchases. For example, if the SKU-level data is unavailable from the one or more financial institutions, the SKU-level data may instead be included in the user’s loyalty program data. Further, the loyalty program data may provide back-end computing system with a more complete picture of the user’s purchases. For example, the loyalty program data may indicate that the user purchases item X or brand Y when item X or brand Y is on sale to members of the retailer’s loyalty program.

In some embodiments, one or more third party systems 106 may be representative of one or more retailers and/or one or more suppliers. API module 118 may be configured to interface with one or more retailers or one or more suppliers to retrieve or receive product availability and pricing information. For example, to provide a more complete recommendation to a user, API module 118 may receive or retrieve availability and pricing information for the inventory of one or more suppliers and/or one or more retailers. In this manner, machine learning platform 116 can provide the user with a more complete recommendation, based on the availability and price of items the user purchases and/or equivalent substitutions or alternatives to the items the user purchases. Such information may also aid machine learning platform 116 in recommending a particular retailer or particular location at which to purchase items.

In some embodiments, one or more third party systems 106 may be representative of one or more news sources or social media feeds. API module 118 may be configured to interface with one or more news sources or social media feeds to retrieve or receive current event information. Such current event information may assist machine learning platform 116 in providing an accurate or more complete recommendation to a user. For example, information such as national health pandemics, food shortages, worker strikes, supply chain disruptions, holidays, and/or turbulent weather may assist machine learning platform 116 in accurately forecasting or projecting the user’s future purchases.

Purchasing engine 120 may be configured to execute a purchase of recommended items. For example, based on a recommendation generated by machine learning platform 116 and/or selections from the user, purchasing engine 120 may interface with a third party system 106 to execute or initiate a purchase. In some embodiments, purchasing engine 120 may be granted permission by a user of client device 102 to interface with an application locally executing on client device 102 to execute a purchase. For example, a user of client device 102 may grant purchasing engine 120 permission to Amazon Fresh or Instacart to execute a transaction on behalf of the user.

FIG. 2 is a block diagram illustrating machine learning platform 116, according to example embodiments. As provided above, machine learning platform 116 may be configured to provide personalized recommendations for household purchases by learning personalized preferences of each user in its user base.

Machine learning platform 116 may include pre-processing module 202 and clustering model 204. Pre-processing module 202 may be configured to receive user level. In some embodiments, pre-processing module 202 may receive user level data from local storage (not shown). In some embodiments, pre-processing module 202 may receive user level data from one or more third party systems 106 (e.g., financial institutions) by way of API module 118. The user level data may include personal identification information of each user. For example, the user level data may include, but is not limited to, name, address (e.g., street, city, state, zip code), income information, household information (e.g., number of family members, number of dependents, number of pets), demographic information (e.g., age, race, ethnicity, gender, education, etc.), and/or employment information. In some embodiments, pre-processing module 202 may be configured to perform one or more operations on the user level data so that the user level data is anonymized. For example, pre-processing module 202 may strip out any sensitive information that could uniquely identify the user. Using a specific example, pre-processing module 202 can obfuscate information, such as the name and street address of the user, by hashing those text strings. In another example, pre-processing module 202 may simply remove of omit name and street address information of the user in favor of generic placeholders, such as, but not limited to, User 1, Street 1, etc.

Clustering model 204 may be configured to analyze the pre-processed user level data to generate one or more clusters 206 of users. For example, to generate a more complete overview of a user’s personal consumption habits, it may be beneficial to machine learning platform 116 to ingest or analyze data related to other users that are demographically similar to a target user. In this manner, clustering model 204 may cluster the user base into one or more clusters 206 of users. Clustering model 204 may utilize one or more clustering models, such as, but not limited to, k-means clustering, mean-shift clustering, distribution-based clustering, density-based clustering, and the like. In this manner, clustering model 204 may group or cluster the user based into a plurality of clusters 206 for downstream analysis.

Machine learning platform 116 may further include pre-processing module 208 and a plurality of training modules: training module 222, training module 224, training module 226, and training module 228.

Pre-processing module 208 may be configured to receive clusters 206 from clustering model 204 and various data to generate training sets for each of training module 222, training module 224, training module 226, and training module 228. For example, for each user, pre-processing module 208 may receive transaction data associated with various transactions. In some embodiments, pre-processing module 208 may receive the transaction data from one or more financial institutions by way of API module 118. In some embodiments, for each user, pre-processing module 208 may further receive loyalty program data from one or more retailers via API module 118. From the transaction data and/or loyalty data, pre-processing module 208 may be provided with SKU-level data for each user’s purchases. In this manner, pre-processing module 208 may receive a list of items purchased by the user for each transaction.

In some embodiments, pre-processing module 208 may further receive contextual information for the transaction data. For example, pre-processing module 208 may receive or retrieve historical event data from one or more news feeds and/or social media websites. Such historical event data may be useful to provide context to the user’s purchases. For example, if the user purchased heavily in bulk in March 2020 and April 2020, the historical event data associated with those dates may indicate that an international pandemic had started.

Pre-processing module 208 may be configured to aggregate the transaction data, loyalty program data, and/or historical event data into one or more training data sets. In some embodiments, pre-processing module 208 may perform one or more operations on the transaction data, loyalty program data, and/or historical event data to standardize the data into an easily readable format for each of training module 222, training module 224, training module 226, and training module 228. In some embodiments, pre-processing module 208 may aggregate or group the transaction data, loyalty program data, and/or historical event data into one or more training data sets based on assigned cluster. In this manner, transaction data, loyalty program data, and/or historical event data for similar users may be grouped in the same training data set.

Training module 222 may be configured to train machine learning model 232 to learn user purchase habits. For example, based on the training data sets, training module 222 may train machine learning model 232 to learn items the users purchase, a volume of each item the users purchase, and customer demand for each item. In some embodiments, machine learning model 232 may learn the items the users purchase based on the SKU-level data. Machine learning model 232 may also learn the items the users purchase based on contextual data, such as current events. For example, during the holidays, users may have a different “baseline” spending pattern than they do outside of the holiday seasons. Using another example, during turbulent weather, users may have a different “baseline” spending pattern compared to a default baseline spending pattern.

In some embodiments, machine learning model 232 may learn to predict user purchases, volumes of user purchases, and customer demand for items across users in a cluster. Training module 222 may further train or fine tune machine learning model 232 for each individual user following training across the cluster of users. Such process may allow machine learning model 232 to learn a user’s baseline spending habits. As output, training module 222 may generate an individualized prediction model 242 for each user.

In some embodiments, machine learning model 232 may be representative of one or more machine learning models. Exemplary machine learning models or algorithms may include, but are not limited to, random forest model, support vector machines, neural networks, deep learning models, Bayesian algorithms, Temporal Convolutional Networks, and the like.

Training module 224 may be configured to train machine learning model 234 to identify items that are similar to each other. For example, based on training data sets that include SKU-level data for purchases, machine learning model 234 may learn those items that can be substituted for each other. Using a specific example, for toilet paper, machine learning model 234 may learn that Charmin is an acceptable replacement for Cottonelle. Using another example, machine learning model 234 may learn that an acceptable replacement for apples may be pears for certain users based on their purchasing habits. For example, based on user purchasing habits, machine learning model 234 may learn that users typically buy apples or pears, but not both at the same time. This may indicate that users deem the two fruits to be equally acceptable.

Machine learning model 234 may further learn which items can be substituted for each other based on volume and pricing. For example, users may not deem two six packs of toilet paper to be an acceptable replacement to a twelve pack of toilet paper due to the price increase of two six packs compared to a twelve pack.

In some embodiments, machine learning model 234 may learn those items that are acceptable replacements across users in a cluster. Training module 224 may further train or fine tune machine learning model 234 for each individual user following training across the cluster of users. Such process may allow machine learning model 234 to learn what is an acceptable replacement or substitution to the user.

As output, training module 224 may generate a comparison module 244.

In some embodiments, machine learning model 234 may be representative of one or more machine learning models. Exemplary machine learning models or algorithms may include, but are not limited to, random forest model, support vector machines, neural networks, deep learning models, Bayesian algorithms, Temporal Convolutional Networks, and the like.

Training module 226 may be configured to train machine learning model 236 to generate metadata for various items. For example, based on training data sets that include SKU-level data for purchases, machine learning model 236 may learn tags that may be relevant to certain items or purchases. In some embodiments, training module 226 may utilize purchase review data. For example, by collecting review data, machine learning model 236 may learn themes related to the product categories. Using a specific example, assume that a user buys coconut water in 24 packs. Based on the shipping weight and measurements, machine learning module 236 may identify that this product is consider large / heavy, which matches one of the themes identified from a review: “Family Pack, Good for Family.”

By collecting specification information for a product (e.g., “green” packaging) and by utilizing review data, machine learning module 236 may learn tags (e.g., reusable packaging), that can be item of metadata for the product.

In another example, similar techniques may be applied to product branding as well. For example, review and rating information may be retrieved for the brand. In this manner, machine learning model 236 may learn to map positive and/or negative traits to specific brands instead of individual products of the brand.

As output, from the above training, training module 226 may generate metadata model 246. Metadata model 246 may be able the match an item, based on its SKU, with different metatags.

In some embodiments, machine learning model 236 may be representative of one or more machine learning models. Exemplary machine learning models or algorithms may include, but are not limited to, random forest model, support vector machines, neural networks, deep learning models, Bayesian algorithms, Temporal Convolutional Networks, and the like.

Training module 228 may be configured to train machine learning model 238 to learn relationships between items purchased by users. For example, based on training data sets that include SKU-level data for purchases, machine learning model 236 may learn which other items are frequently purchased with a target item. Using a specific example, given taco shells, machine learning model 238 may learn that users that buy taco shells also frequently buy, with the taco shells, a protein (e.g., chicken, ground beef, steak, etc.), shredded cheese, shredded lettuce, onions, and salsa. Using another example, given cough drops, machine learning model 238 may learn that users that buy cough drops also frequently buy, with the cough drops, tissues, soup, and decongestants. In this manner, machine learning model 238 may be trained to learn relationships of items in a user’s basket to accurately generate or forecast a shopping list for the user. As output, training module 228 may generate a relationship model 248.

In some embodiments, machine learning model 238 may learn relationships between items across users in a cluster. Training module 224 may further train or fine tune machine learning model 234 for each individual user following training across the cluster of users. Such process may allow machine learning model 234 to relationships between items purchased for each individual user. Continuing with the above example, User A may purchase chicken with taco shells, while User B may purchase steak with taco shells.

As output, training module 224 may generate a comparison module 244.

Prediction model 242, comparison model 244, metadata model 246, and relationship model 248 may define a recommendation engine 250 of machine learning platform 116. Recommendation engine 250 may be configured to generate a new transaction for a user based on the user’s baseline spending pattern and one or more external factors. For example, based on inventory data associated with one or more facilities (e.g., retailers, suppliers, etc.) and/or current event data, recommendation engine 250 may propose a transaction for the user. In some embodiments, recommendation engine 250 may propose a transaction for the user when recommendation engine 250 determines that an item the user is likely to buy is running low within a radius of the user. For example, if the user frequently buys Topo Chico mineral water on a biweekly basis, recommendation engine 250 may recommend that the user buy Topo Chico mineral water ahead of the user’s typical purchase date due to low inventory in retailers around the user. Accordingly, recommendation engine 250 may notify the user that they should purchase the item before the stock for the item is depleted.

In some embodiments, recommendation engine 250 may propose a transaction for the user when recommendation engine 250 determines that turbulent weather is coming. For example, if there is forecasted to be a blizzard, recommendation engine 250 may generate a transaction for the user that includes the user’s essential items (as learned during training) with a volume amount that accounts for the uncertainty of future forecasts and future inventory. In some embodiments, recommendation engine 250 may recommend more shelf stable items or frozen items if there is turbulent weather, since it may be more difficult for the user to shop in the future.

Recommendation engine 250 may generate a shopping list for the user based on the user’s baseline spending pattern. Based on inventory data of retailers that the user typically frequents, recommendation engine 250 may adjust the shopping list based on the available stock of items the user typically purchases. For example, if the user typically buys Charmin toilet paper but it is low in stock, recommendation engine 250 may propose Cottonelle toilet paper in the shopping list. In another example, if the user typically buys a standard sized bag of Nacho Cheese Doritos but the Family Sized bag of Nacho Cheese Doritos is on sale, recommendation engine 250 may adjust the shopping list to include the Family Sized bag of Nacho Cheese Doritos.

In some embodiments, recommendation engine 250 can scale up or down a recommended transaction based on updated transaction data from the user. For example, if recommendation engine 250 receives updated transaction data for a user in which recommendation engine 250 determines that the user has procured four weeks’ worth of supplies instead of the user’s normal procurement of two weeks, recommendation engine 250 can remap the volume of items in the recommended transaction.

In this manner, recommendation engine 250 may dynamically provide the user with a recommended transaction based on best matching items, best value items, and/or best availability of items.

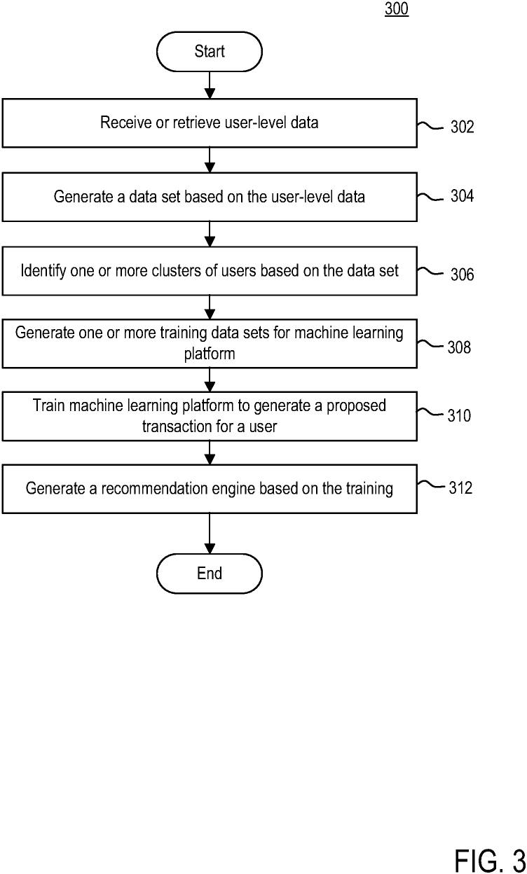

FIG. 3 is a flow diagram illustrating a method 300 of generating a recommendation engine, according to example embodiments. Method 300 may begin at step 302.

At step 302, back-end computing system 104 may receive or retrieve user-level data. For example, pre-processing module 202 may receive user level data from one or more third party systems 106 via API module 118. The user level data may include personal identification information of each user. For example, the user level data may include, but is not limited to, name, address (e.g., street, city, state, zip code), income information, household information (e.g., number of family members, number of dependents, number of pets), demographic information (e.g., age, race, ethnicity, gender, education, etc.), and/or employment information.

At step 304, back-end computing system 104 may generate a data set based on the user-level data. For example, pre-processing module 202 may perform one or more operations on the user level data so that the user level data is anonymized. For example, pre-processing module 202 may strip out any sensitive information that could uniquely identify the user by obfuscating or omitting certain sensitive information, such as the name and street address of the user.

At step 306, back-end computing system 104 may identify one or more clusters of users based on the data set. For example, clustering model 204 may analyze the data set to generate one or more clusters of users. Such clustering technique may assist in generating a more complete overview of a user’s personal consumption habits, as it may be beneficial to machine learning platform 116 to ingest or analyze data related to other users that are demographically similar to a target user. Clustering model 204 may utilize one or more clustering models, such as, but not limited to, k-means clustering, mean-shift clustering, distribution-based clustering, density-based clustering, and the like.

At step 308, back-end computing system 104 may generate one or more training data sets for machine learning platform 116. For example, pre-processing module 208 may be configured to receive clusters from clustering model 204 and various data to generate training sets for each of training module 222, training module 224, training module 226, and training module 228. Pre-processing module 208 may receive transaction data associated with various transactions from one or more financial institutions via API module 118. In some embodiments, for each user, pre-processing module 208 may further receive loyalty program data from one or more retailers via API module 118. From the transaction data and/or loyalty data, pre-processing module 208 may be provided with SKU-level data for each user’s purchases.

In some embodiments, pre-processing module 208 may further receive contextual information for the transaction data. For example, pre-processing module 208 may receive or retrieve historical event data from one or more news feeds and/or social media websites

To generate the training data sets, pre-processing module 208 may aggregate the transaction data, loyalty program data, and/or historical event data into one or more training data sets. In some embodiments, pre-processing module 208 may perform one or more operations on the transaction data, loyalty program data, and/or historical event data to standardize the data into an easily readable format for each of training module 222, training module 224, training module 226, and training module 228. In some embodiments, pre-processing module 208 may aggregate or group the transaction data, loyalty program data, and/or historical event data into one or more training data sets based on assigned cluster.

At step 310, back-end computing system 104 may train machine learning platform 116 to generate a proposed transaction for a user. Training module 222 may train machine learning model 232 to learn user purchase habits. For example, based on the training data sets, training module 222 may train machine learning model 232 to learn items the users purchase, a volume of each item the users purchase, and customer demand for each item. Training module 224 may train machine learning model 234 to identify items that are similar to each other. For example, based on training data sets that include SKU-level data for purchases, machine learning model 234 may learn those items that can be substituted for each other. Training module 226 may be configured to train machine learning model 236 to generate metadata for various items. For example, based on training data sets that include SKU-level data for purchases, machine learning model 236 may learn tags that may be relevant to certain items or purchases. Training module 228 may train machine learning model 238 to learn relationships between items purchased by users. For example, based on training data sets that include SKU-level data for purchases, machine learning model 236 may learn which other items are frequently purchased with a target item.

At step 312, back-end computing system 104 may generate a recommendation engine 250 based on the training. For example, as output, training module 222 may generate prediction model 242, training module 224 may generate comparison model 244, training module 226 may generate metadata model 246; and training module 228 may generate relationship module 248. Prediction model 242, comparison model 244, metadata model 246, and relationship module 248 may represent a fully-trained recommendation engine 250 for recommending transactions to users.

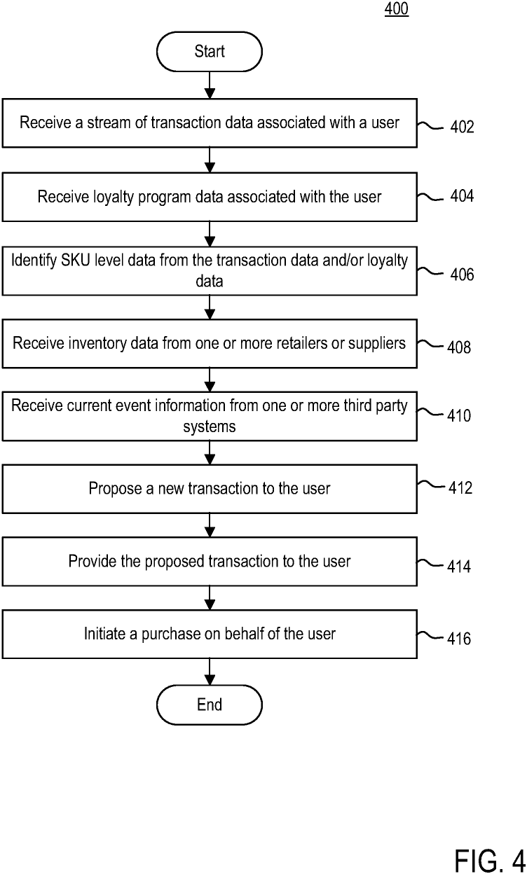

FIG. 4 is a flow diagram illustrating a method 400 of generating a proposed transaction for a user, according to example embodiments. Method 400 may begin at step 402.

At step 402, back-end computing system 104 may receive a stream of transaction data associated with the user. In some embodiments, pre-processing module 208 may receive the transaction data from one or more financial institutions via API module 118. In some embodiments, the stream of transaction data is received in real-time or near real-time. In some embodiments, the stream of transaction data is received on a continual or rolling basis, such that back-end computing system 104 may be provided with an up-to-date picture of the user’s transactions.

At step 404, back-end computing system 104 may receive loyalty program data from one or more retailers via API module 118. In some embodiments, the loyalty data is received in real-time or near real-time. In some embodiments, the loyalty data is received on a continual or rolling basis, such that back-end computing system 104 may be provided with an up-to-date picture of the user’s transactions.

At step 406, back-end computing system 104 may identify SKU level data from the transaction data and/or loyalty data. For example, from the transaction data and/or loyalty data, pre-processing module 208 may identify SKU-level data for each user’s purchases. In some embodiments, pre-processing module 208 can derive SKU-level data from the transaction data and/or loyalty data. For example, pre-processing module 208 may map transactions in the transaction data to items purchased in the loyalty data. In this manner, pre-processing module 208 may identify a list of items purchased by the user for each transaction and a volume of each item.

At step 408, back-end computing system 104 may receive inventory data from one or more retailers or suppliers with which the user frequently visits. For example, machine learning platform 116 may identify those items that retailers, suppliers, or locations have in stock.

At step 410, back-end computing system 104 may receive current event information from one or more third party systems 106. Based on the event data, machine learning platform 116 may determine whether there is an abnormal event on the horizon. For example, machine learning platform 116 may identify that there is turbulent weather over the next week. In another example, machine learning platform 116 may identify that the local sports team is playing a high stakes game over the next week. In another example, machine learning platform 116 may identify that there is an upcoming holiday.

At step 412, back-end computing system 104 may propose a new transaction to the user based on the transaction history, the inventory data, and/or the current event information. For example, using the user’s determined baseline spending pattern, machine learning platform 116 may generate a proposed transaction for the user. In some embodiments, the proposed transaction may take the form of an entire shopping list.

At step 414, back-end computing system 104 may provide the user with the proposed transaction. In some embodiments, providing the user with the proposed transaction may include emailing the user with the proposed transaction. In some embodiments, providing the user with the proposed transaction may include pushing a notification with the proposed transaction to the user. In some embodiments, providing the user with the proposed transaction may include interfacing with intelligent assistant 110 to prompt the user.

In some embodiments, method 400 may include step 416. At step 416, back-end computing system 104 may initiate a purchase on behalf of the user. For example, after prompting the user with the proposed transaction, the user may provide input that prompts back-end computing system 104 to initiate the proposed transaction on behalf of the user. When prompted, purchasing engine 120 may initiate the proposed transaction. In some embodiments, initiating the transaction on behalf of the user may include purchasing engine 120 interfacing with a third party application (e.g., Amazon Fresh, Instacart, etc.) on client device 102.

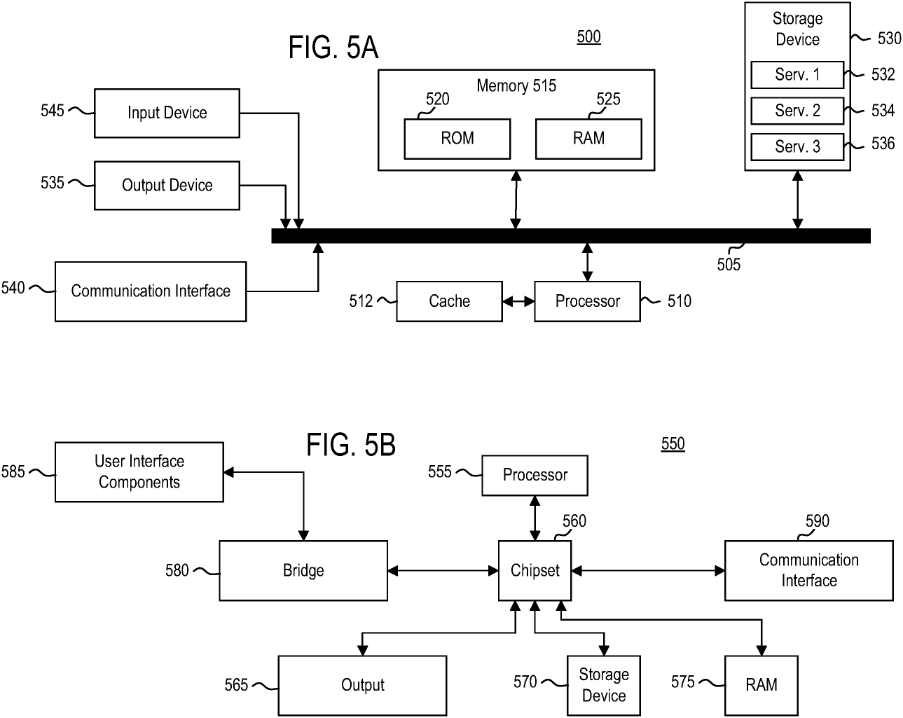

FIG. 5A illustrates an architecture of system bus computing system 500, according to example embodiments. One or more components of system 500 may be in electrical communication with each other using a bus 505. System 500 may include a processor (e.g., one or more CPUs, GPUs or other types of processors) 510 and a system bus 505 that couples various system components including the system memory 515, such as read only memory (ROM) 520 and random access memory (RAM) 525, to processor 510. System 500 can include a cache of highspeed memory connected directly with, in close proximity to, or integrated as part of processor 510. System 500 can copy data from memory 515 and/or storage device 530 to cache 512 for quick access by processor 510. In this way, cache 512 may provide a performance boost that avoids processor 510 delays while waiting for data. These and other modules can control or be configured to control processor 510 to perform various actions. Other system memory 515 may be available for use as well. Memory 515 may include multiple different types of memory with different performance characteristics. Processor 510 may be representative of a single processor or multiple processors. Processor 510 can include one or more of a general purpose processor or a hardware module or software module, such as service 1 532, service 2 534, and service 3 536 stored in storage device 530, configured to control processor 510, as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the system 500, an input device 545 which can be any number of input mechanisms, such as a microphone for speech, a touch-sensitive screen for gesture or graphical input, keyboard, mouse, motion input, speech and so forth. An output device 535 (e.g., a display) can also be one or more of a number of output mechanisms known to those of skill in the art. In some instances, multimodal systems can enable a user to provide multiple types of input to communicate with system 500. Communications interface 540 can generally govern and manage the user input and system output. There is no restriction on operating on any particular hardware arrangement and therefore the basic features here may easily be substituted for improved hardware or firmware arrangements as they are developed.

Storage device 530 may be a non-volatile memory and can be a hard disk or other types of computer readable media that can store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 can include services 532, 534, and 536 for controlling the processor 510. Other hardware or software modules are contemplated. Storage device 530 can be connected to system bus 505. In one aspect, a hardware module that performs a particular function can include the software component stored in a computer-readable medium in connection with the necessary hardware components, such as processor 510, bus 505, output device 535 (e.g., a display), and so forth, to carry out the function.

FIG. 5B illustrates a computer system 550 having a chipset architecture, according to example embodiments. Computer system 550 may be an example of computer hardware, software, and firmware that can be used to implement the disclosed technology. System 550 can include one or more processors 555, representative of any number of physically and/or logically distinct resources capable of executing software, firmware, and hardware configured to perform identified computations. One or more processors 555 can communicate with a chipset 560 that can control input to and output from one or more processors 555. In this example, chipset 560 outputs information to output 565, such as a display, and can read and write information to storage device 570, which can include magnetic media, and solid-state media, for example. Chipset 560 can also read data from and write data to storage device 575 (e.g., RAM). A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 555 analyzing data stored in storage device 570 or 575. Further, the machine can receive inputs from a user through user interface components 585 and execute appropriate functions, such as browsing functions by interpreting these inputs using one or more processors 555.

It can be appreciated that example systems 500 and 550 can have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A non-transitory computer readable medium comprising one or more sequences of instructions, which, when executed by a processor, causes a computing system to perform operations comprising:
generating, by the computing system, a first prediction model to identify baseline spending patterns across a plurality of users and relationships between items by:
generating, by the computing system, a training data set comprising historical transaction data associated with the plurality of users, wherein the historical transaction data comprises stock-keeping unit (SKU) level data,
learning, by the first prediction model, to generate the baseline spending patterns based on the historical transaction data, and
learning, by the first prediction model, the relationships between items to an order based on the historical transaction data;
generating, by the computing system, an individualized prediction model for a first user by:
accessing transaction data corresponding to the first user of the plurality of users, and
learning, by the individualized prediction model, a baseline spending pattern of the first user based on the transaction data;
receiving, by the computing system, inventory data corresponding to one or more merchants with which the first user has transacted, wherein the inventory data comprises SKU level data;
accessing, by the computing system, a news feed to identify upcoming events or ongoing events; and
recommending, by the individualized prediction model, a new transaction for the first user based on the baseline spending pattern, the inventory data, and the news feed.

2. The non-transitory computer readable medium of claim 1, further comprising:
anonymizing, by the computing system, the historical transaction data prior to training the first prediction model with the historical transaction data.

3. The non-transitory computer readable medium of claim 1, wherein recommending, by the computing system, the new transaction for the first user based on the baseline spending patterns and the inventory data comprises:
interfacing with an intelligent assistant to deliver the recommendation to the first user.

4. The non-transitory computer readable medium of claim 1, wherein recommending, by the computing system, the new transaction for the first user based on the baseline spending pattern and the inventory data comprises:
determining, by the individualized prediction model, that stock for an item is expected to be depleted within a radius of the first user; and
based on the determining, notifying the first user to purchase the item before the stock for the item is depleted within the radius.

5. The non-transitory computer readable medium of claim 1, further comprising:
for each item in the transaction data, learning, by the first prediction model, a plurality of replacement items based on the transaction data.

6. The non-transitory computer readable medium of claim 5, wherein recommending, by the computing system, the new transaction for the first user based on the baseline spending pattern and the inventory data comprises:
notifying the first user that a frequently purchased item is out of stock within a radius location of the first user; and
suggesting that the first user purchase a second item, wherein the second item is a replacement item for the frequently purchased item.

7. The non-transitory computer readable medium of claim 1, further comprising:
prompting, by the computing system, the first user to submit an order for the new transaction with a merchant.

8. A method, comprising:
retrieving, by a computing system, historical transaction data associated with a plurality of users, wherein the historical transaction data comprises stock-keeping unit (SKU) level data;
training, by the computing system, a first prediction model to identify transaction patterns across the plurality of users and relationships between items to each transaction based on the historical transaction data;
accessing, by the computing system, transaction data corresponding to a first user of the plurality of users;
generating, by the computing system, a second prediction model by fine-tuning the first prediction model based on the transaction data of the first user;
receiving, by the computing system, inventory data corresponding to one or more merchants with which the first user has transacted, wherein the inventory data comprises SKU level data;
accessing, by the computing system, a news feed to identify upcoming events or ongoing events;
learning, by the second prediction model, a baseline spending pattern of the first user based on the transaction data; and
recommending, by the computing system, a new transaction for the first user based on the baseline spending pattern, the inventory data, and the news feed.

9. The method of claim 8, further comprising:
anonymizing, by the computing system, the historical transaction data prior to training the first prediction model with the historical transaction data.

10. The method of claim 8, wherein recommending, by the computing system, the new transaction for the first user based on the baseline spending pattern and the inventory data comprises:
interfacing with an intelligent assistant to deliver the recommendation to the first user.

11. The method of claim 8, wherein recommending, by the computing system, the new transaction for the first user based on the baseline spending pattern and the inventory data comprises:
determining, by the second prediction model, that stock for an item is expected to be depleted within a radius of the first user; and
based on the determining, notifying the first user to purchase the item before the stock for the item is depleted within the radius.

12. The method of claim 8, further comprising:
for each item in the transaction data, learning, by the first prediction model, a plurality of replacement items based on the transaction data.

13. The method of claim 12, wherein recommending, by the computing system, the new transaction for the first user based on the baseline spending pattern and the inventory data comprises:
notifying the first user that a frequently purchased item is out of stock within a radius location of the first user; and
suggesting that the first user purchase a second item, wherein the second item is a replacement item for the frequently purchased item.

14. The method of claim 8, further comprising:
prompting, by the computing system, the first user to submit an order for the new transaction with a merchant.

15. A system, comprising:
a processor; and
a memory having programming instructions stored thereon, which, when executed by the processor, causes the processor to perform operations comprising:
generating a first prediction model to identify baseline spending patterns across a plurality of users and relationships between items by:
generating a training data set comprising historical transaction data associated with the plurality of users, wherein the historical transaction data comprises stock-keeping unit (SKU) level data,
learning, by the first prediction model, to generate the baseline spending patterns based on the historical transaction data, and
learning, by the first prediction model, the relationships between items to an order based on the historical transaction data; generating an individualized prediction model for a first user by:
accessing transaction data corresponding to the first user of the plurality of users, and
learning, by the individualized prediction model, a baseline spending pattern of the first user based on the transaction data;
receiving inventory data corresponding to one or more merchants with which the first user has transacted, wherein the inventory data comprises SKU level data;
accessing a news feed to identify upcoming events or ongoing events;
predicting, by the individualized prediction model, that the first user will need to re-order an item based on the baseline spending pattern, the inventory data, and the news feed; and
based on the predicting, recommending a new transaction for the first user.

16. The system of claim 15, wherein the operations further comprise:
anonymizing the historical transaction data prior to training the first prediction model with the historical transaction data.

17. The system of claim 15, wherein recommending the new transaction for the first user comprises:
interfacing with an intelligent assistant to deliver the recommendation to the first user.

18. The system of claim 15, wherein predicting, by the individualized prediction model, that the user will need to re-order the item based on the baseline spending pattern, the inventory data, and the news feed comprises:
determining, by the individualized prediction model, that stock for the item is expected to be depleted within a radius of the first user; and
based on the determining, notifying the first user to purchase the item before stock for the item is depleted within the radius.

19. The system of claim 15, wherein the operations further comprise:
for each item in the transaction data, learning, by the first prediction model, a plurality of replacement items based on the transaction data.

20. The system of claim 19, wherein recommending the new transaction for the first user comprises:
notifying the first user that a frequently purchased item is out of stock within a radius of the first user; and
suggesting that the first user purchase a second item, wherein the second item is a replacement item for the frequently purchased item.
